(19) United States
(12) Patent Application Publication
(10) Pub. No.: US 2002/0095402 A1
(43) Pub. Date: Jul. 18, 2002

(54) Automated data collection and transmission

(76) Inventors: Douglas Brown Dillard, Athens, GA (US); Robert Bradford Gray, Athens, GA (US); John Ashwell Raymond, Athens, GA (US)

Correspondence Address: KING & SPALDING, 191 PEACHTREE STREET, N.E., ATLANTA, GA, 30303-1763, US

(21) Appl. No.: 10/051,616

(22) Filed: Jan. 18, 2002

Related U.S. Application Data
(60) Provisional application No. 60/262,601, filed on Jan. 18, 2001.

(51) Int. Cl. G06F 7/00

(52) U.S. Cl. 707/1

(57) ABSTRACT

Direct order entry is enabled through the use of a hand-held independent computer that coordinates the entry and transmission of data between a data entry enterprise and a data receiving enterprise. Software and data can be delivered to a data center that can transmit the software and data the hand-held computer. Data can be directly entered into the hand-held computer in an off-line mode and subsequently transmitted to the data center in an on-line mode. The handheld computer provides full freedom of movement in the off-line mode and precise data transmission in the on-line mode, thereby reducing or eliminating data entry error.

### PRIORITY AND RELATED APPLICATIONS

The present application claims priority to provisional patent application entitled, “Automated Order Entry Using Hand Held Device,” filed on Jan. 18, 2001 and assigned U.S. Application Serial No. 60/262,601.

### FIELD OF THE INVENTION

The present invention relates to data collection systems and more particularly relates to facilitating data collection and transmission through the use of a hand-held data entry computer.

### BACKGROUND OF THE INVENTION

Conventional data entry applications suffer from a well-known accountability gap. In one form or another every automated system depends on the data with which it is provided. When humans are responsible for the provision of data to an automated system, human error can be propagated through the automated system and can result in unexpected errors and unintended consequences. Human errors include the entry of incorrect data and the failure to input expected data. The accountability gap arises because the origin of the error is typically untraceable. Errors incur costs, but the final user of the data always bears these costs if no accountability exists.

The restaurant industry provides a good example of how erroneous data can wreak havoc in an automated system. In the foodservice industry, there are primarily of two players: the restaurant and the distributor. The restaurant sells prepared food to its customers and buys food supplies from the distributor. The typical restaurant operates under tight constraints: it has a fixed menu and a predictable number of anticipated customers expecting to order prepared food from that menu. In addition, because food supplies are perishable, the restaurant has a continually short lead-time. As a result, the restaurant continually needs the food supplies and needs them soon. If, due to ordering errors, the distributor fails to deliver the food supplies within the short lead-time, the restaurant will turn elsewhere for its food supplies. Thus the distributor is forced to take expensive measures to correct the error within an extremely short time. If the distributor delivers the wrong food supplies, there is often not enough time to correct the delivery, and spoilage of the wrong food supplies may result in its loss to the distributor. In short, the restaurant and the distributor both share the goal of delivering an accurate order of food supplies within an agreed upon lead-time.

Unfortunately, the conventional order-entry systems used in the restaurant industry often frustrate this shared goal. Restaurants generally use two kinds of orders: a standard order, which consists of largely the same items on a fairly regular basis (e.g., weekly), and an on-demand order, which consists of items needed on an unexpected basis (e.g., when supplies are depleted because a particular menu item sells better than expected). The standard order can be built and refined over time and can, therefore, be quite stable. The on-demand order is by definition, unstable and unpredictable. Restaurant personnel usually adjust a standard order prior to placing it with the distributor. For example, a restaurant employee will typically walk through a stock room, a refrigerated room, and/or a freezer to determine which of the standard order items have been depleted and what quantities of each should be ordered. Once the standard order has been adjusted to reflect these actual requirements, the order can be placed Typically, a designated restaurant employee contacts the distributor's order entry personnel by telephone. Reading from a handwritten standard order or from a handwritten on-demand order, the restaurant employee verbally conveys the order to the distributor's order entry employee. The distributor's employee generally records the order by hand on an order entry form. Subsequently, the order entry form may be passed to a data entry clerk who will enter the order into the automated order entry system (i.e., computer).

Accordingly, there are multiple opportunities for error to enter and propagate through the conventional order-entry system. The order may be recorded incorrectly or written illegibly by the restaurant personnel. Even if the order is accurately and legibly written, the restaurant personnel may read the order sheet incorrectly. The distributor's employee may record the order incorrectly on the order entry form. The order entry clerk may input the wrong data into the automated system. The probability of an error-causing event is increased by the fact that the personnel are typically not skilled in the restaurant business and lack the judgment to question and correct errors as they occur.

Preprinted paper forms have been employed to reduce the errors described. While the use of forms tends to reduce errors, the written and verbal errors described are still an obstacle to accurate order entry.

An approach that has been attempted to reduce order entry error is the use of on-line order entry systems. Such systems have the advantage of eliminating any misunderstanding between the restaurant and distributor personnel that may cause an error. These systems also reduce the error caused by any misunderstanding between personnel within the distributor. However, this approach requires the restaurant personnel to generate written orders prior to accessing the on-line order-entry system. Accordingly, any errors generated by the initial step of recording the order by hand are not reduced or eliminated by such on-line order entry systems. In addition, on-line systems typically employ the Internet for data transmission, which remains a relatively unreliable data transmission means, particularly in an industry where timeliness is paramount.

While the problem of data entry errors has been described in relation to the restaurant industry, the reduction of human error during data entry into computing systems is a goal that is shared by any industry or endeavor that relies on data entry and the reliability of the entered data. In view of the foregoing, there is a need for a method of entering data and/or orders in an automated way that will reduce human error in the order entry process. There exists a further need to reduce the opportunity for human data entry error in an automated data entry system. The method should further reduce the number of personnel needed to perform data entry in a single-enterprise or multiple-enterprise data entry environment.

### SUMMARY OF THE INVENTION

The present invention provides a system and method for automated data entry using an independent hand-held computer. The present invention can be implemented as a gateway between a data entry enterprise and a data collection enterprise. For example, the data entry enterprise may be a restaurant, while the data collection enterprise may be a food supplies distributor. The gateway or data center can be used to collect data from the data entry enterprise and to deliver that data to the data collection enterprise. In addition, the data center can be used to transmit software and/or data from the data collection enterprise and deliver the software and/or data to the data enterprise. Accordingly, data entry can be facilitated by the use of the hand-held computer to reduce the occurrence of human error in the data entry process. The hand-held computer typically operates in an off-line mode during data collection and will operate in an on-line mode for data transmission. The system also can include a cradle associated with each hand-held computer. The cradle can provide various data transmission functionality and can be used to initiate and support the on-line mode of operation. Alternatively, the cradle may be implemented as a pass-through device, providing only a functional connection to a network (e.g., telephone connector) and/or a power supply.

The system can include three main components. The first component is a computer or automated data collection system associated with the data collection enterprise. The second component is the gateway or data center, which provides a central location for data transmission and forms the majority of the computing required. The data center also processes and/or translates data transmitted between the data collection enterprise and the wireless hand-held terminals. The third component is the combination of the independent hand-held computer and the cradle. This combination is used by the data entry enterprise to enter, store, and transmit data to the data collection enterprise.

The advantages of the system and the method of the present invention are numerous. By enabling automated order entry, the system drastically reduces human error in data entry, thereby reducing operating costs and increasing profitability for all involved enterprises. The system can be implemented in connection with existing automated data entry systems, including internet-based systems. The system of the present invention reduces the so-called accountability gap by associating all data entry with the corresponding data entry personnel. By controlling the data transmission and collection, the system of the present invention provides access to the collected data for analyses. In addition, the system can be configured so that the data collection enterprise can solicit data entry and transmission by the data entry enterprise. This capability can reduce the likelihood of missed or forgotten data entry events.

The shape of the hand-held computer is another advantage of the present invention. The hand-held has a hand grip on one side and an input/output area on its top surface. The input/output area includes a combined display and a touchpad input device. The display can be configured to render the visual output of the computer in four directions. The grip is designed to be ergonomically accommodating to a user's hand. The four-direction capabilities of the display and the shape of the hand grip are designed to accommodate both right and left handed users. The terminal can be manufactured without buttons, thereby using only virtual buttons that are rendered by the display and activated by finger touch. This feature both simplifies the operation of the hand-held computer and eliminates the need for a stylus or any other additional input device.

The hand-held computer operates in combination with a cradle. The cradle is a separate piece of equipment that functions as the resting place for the handheld computer when not in use. The cradle also can function to provide a communication link between the hand-held computer and the data center. The cradle can include a detector that detects the presence of the hand-held terminal in the cradle. This detector can be used to switch the computer and/or cradle between active and standby modes of operation.

The various aspects of the present invention may be more clearly understood and appreciated from a review of the following detailed description of the disclosed embodiments and by reference to the drawings and claims.

### BRIEF DESCRIPTION OF THE DRAWINGS

FIG. 1 is a block diagram depicting an automated data entry system that is an exemplary embodiment of the present invention.

FIG. 2 is a block diagram depicting the primary components of an exemplary hand-held computer.

FIG. 3 is a block diagram depicting the primary components of a cradle that is an exemplary embodiment of the present invention.

FIG. 4 is a simplified drawing depicting the physical relationship of a hand-held computer that is disconnected from a cradle of an exemplary embodiment of the present invention.

FIG. 5 is a simplified drawing depicting the physical relationship of the hand-held computer inserted into a cradle of an exemplary embodiment of the present invention.

FIG. 6 is a perspective view of a hand-held data entry computer that is an exemplary embodiment of the present invention.

FIG. 7 is a flow chart depicting an exemplary method for data entry and transmission between a hand-held data entry computer and a central computer.

FIG. 8 is a simplified drawing depicting the top surface of an exemplary hand-held computer.

FIG. 9 depicts an access display that may be used to restrict access to the operation of a data entry application running on a hand-held computer of an exemplary embodiment of the present invention.

FIG. 10 depicts a hand-held computer displaying a top-level order-entry menu computer screen.

FIG. 11 depicts an exemplary transmission display that may be rendered on the input/output area of a hand-held computer of an exemplary embodiment of the present invention.

FIG. 12 is a flowchart depicting an exemplary method for managing and order entry transaction.

FIG. 13 is a flowchart depicting an exemplary method for receiving and transmitting a credit request.

FIG. 14 is a flowchart depicting an exemplary method for receiving and transmitting a request for distributor contact.

FIG. 15 is a flowchart depicting an exemplary method for displaying previous orders.

FIG. 16 is a flowchart depicting an exemplary method for transmitting information to a data center.

### DETAILED DESCRIPTION OF THE EXEMPLARY EMBODIMENTS

An exemplary embodiment of the present invention provides a system and method for automated data entry using an independent hand-held computer. The present invention can be implemented as a gateway between a data entry enterprise and a data collection enterprise. The gateway or data center can be used to collect data from the data entry enterprise and to deliver that data to the data collection enterprise. Accordingly, data entry can be facilitated by the use of the independent hand-held computer to reduce the occurrence of human error in the data entry process. The hand-held computer will typically operate in an independent, off-line mode during data collection and will operate in an on-line mode for data transmission. The system also can include a cradle associated with each hand-held computer. The cradle can provide various data transmission functionality and can be used to initiate and support the on-line mode of operation.

The system can include three main components. The first component is a computer or automated data collection system associated with the data collection enterprise. The second component is the gateway or data center, which provides a central location for data transmission and forms the majority of the computing required. The data center also processes and/or translates data transmitted between the data collection enterprise and the independent hand-held computers. The third component is the combination of the hand-held computer and the cradle. This combination is used by the data entry enterprise to enter, store, and transmit data to the data collection enterprise.

The advantages of the system and the method of the present invention are numerous. By enabling automated order entry, the system drastically reduces human error in data entry, thereby reducing operating costs and increasing profitability for all involved enterprises. The system can be implemented in connection with existing automated data entry systems, including internet-based systems. The system of the present invention reduces the so-called accountability gap by associating all data entry with the corresponding data entry personnel. By controlling the data transmission and collection, the system of the present invention provides access to the collected data for analyses. In addition, the system can be configured so that the data collection enterprise can solicit data entry and transmission by the data entry enterprise. This capability can reduce the likelihood of missed or forgotten data entry events.

The shape of the hand-held computer is another advantage of the present invention. The terminal has a hand grip on one side and an input/output area consisting of a display and a touchpad on its top surface. The display can be configured to render the visual output of the terminal in four directions. The grip is designed to be ergonomically accommodating to a user's hand. The four-direction capabilities of the display and the shape of the hand grip are designed to accommodate both right and left handed users. The computer can be manufactured without buttons, thereby using only virtual buttons that are rendered by the display. This feature both simplifies the operation of the hand-held computer and eliminates the need for a stylus or any other additional input device. The hand-held computer operates in combination with a cradle. The cradle is a separate piece of equipment that functions as the resting place for the hand-held computer when not in use. The cradle also functions to provide a communication link between the independent handheld computer and the data center. The cradle can include a detector that detects the presence of the hand-held computer in the cradle. This detector can be used to switch the computer and/or cradle between standby and active modes of operation.

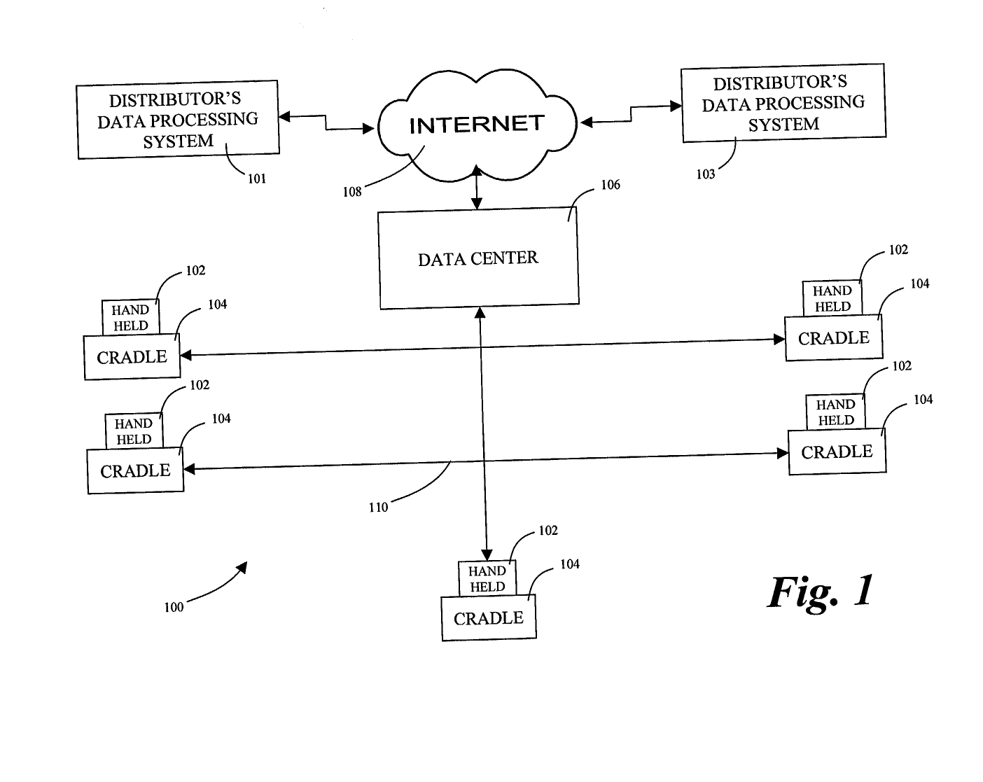

FIG. 1 is a block diagram depicting an automated order entry system that is an exemplary embodiment of the present invention. In a conventional restaurant supply distribution system, a distributor maintains a large inventory of restaurant supplies that can be ordered by a particular restaurant or a group of restaurants. This is not unlike various other well-known distribution systems used to distribute goods and/or services. A common goal of these and other data entry/collection systems is the elimination or reduction of data entry errors. Such errors can generate unnecessary expenses, loss of goodwill among customers, and other adverse effects.

In the automated distribution system of FIG. 1, however, orders can be transmitted to a distributor's computer accurately and efficiently using an automated system that is an exemplary embodiment of the present invention. Using the example of a restaurant supply distribution system, a distributor may maintain a central computer that accepts and processes orders and schedules delivery of those orders. In the automated order entry system, 100 of FIG. 1, the distributor's computer is represented as the “Distributor's Data Processing (DP) System” 101. A second distributor may have a second Distributor's DP System 103. Those skilled in the art will appreciate that any number of Data Processing Systems could be used to implement various embodiments of the present invention. Alternatively, a single Data Processing System could be used as a clearinghouse for multiple distributors.

The Distributors' DP Systems 101, 103 are connected to a data center 106 (or gateway) via an Internet connection 108. Those skilled in the art will appreciate that the connection between the Distributors' DP Systems 101, 103 and the data center 106 could be effected through various means of well-known data transmission, such as a conventional telephone connection. Alternatively, the Distributors' DP Systems 101, 103 could be implemented with the data center 106 as a single, integrated computer system.

The data center 106 can be implemented as a central processing station for data and data transmissions. For example, the data center 106 can be used to aggregate data from various sources (e.g., various restaurants, various restaurant chains) and to sort and consolidate the aggregated data for transmission to a distributor. The data center 106 can intelligently format and translate collected data so that it can be processed by distributors having varying data requirements. The data center 106 may be used to store data transmission profiles associated with each of the distributors to facilitate the data processing and to tailor the transmitted data to the distributors' needs. The data center 106 can also perform data processing to validate certain verifiable data values, such as dates, quantities, etc. and can operate as a data repository to store the histories of the data transmissions between the hand-held computers and the distributors.

Orders can be submitted to the data center 106 via hand-held computers 102. An order can be entered into a hand-held computer and then transmitted to the data center over a data transmission network 110 (e.g., a conventional telephone system). The hand-held computer 102 can transmit the order to the data center 106 when the hand-held 102 is connected to the cradle 104. Among other things, the cradle may be operative to provide a communication link between the hand-held computer 102 and the data center 106, in cooperation with the data transmission network 110. The data transmission network can be a telephonic connection between the cradle 104 and the data center 106. Alternatively, the data transmission network 110 can be an Internet connection between the cradle 104 and the data center 106, or any other well-known means for data communication.

An operator of the Distributor's DP System 101, 103, can transmit data to the hand-held computer 102 over the transmission network 110. In the order-entry context, for example, a distributor operating the Distributor's DP System 101 may submit an electronic order entry form for storage on a hand-held computer 102. For example, a distributor's standard form may have changed and the new form can be transmitted to and stored on the hand-held computer 102. In addition, all forms of data can be transmitted to the hand-held computer 102. For example, the contents of a previous order, a standard order, or an available product list (i.e., inventory list) may be transmitted to the hand-held computer 102 to assist in an order entry procedure. Accordingly, the automated order entry system 100 provides a two-way data communication system connecting a hand-held computer 102 with a Distributor's DP System 101. Those skilled in the art will appreciate that various data communication methodologies could be used to provide a communication link between the Distributor's DP System 101 and the hand-held computer 102. In an exemplary embodiment of the present invention, real-time communication between the hand-held computer 102 and the Distributor's DP System 101 is not attempted when the handheld computer 102 is disconnected from the data communication network 110 (e.g., not connected to the cradle 104).

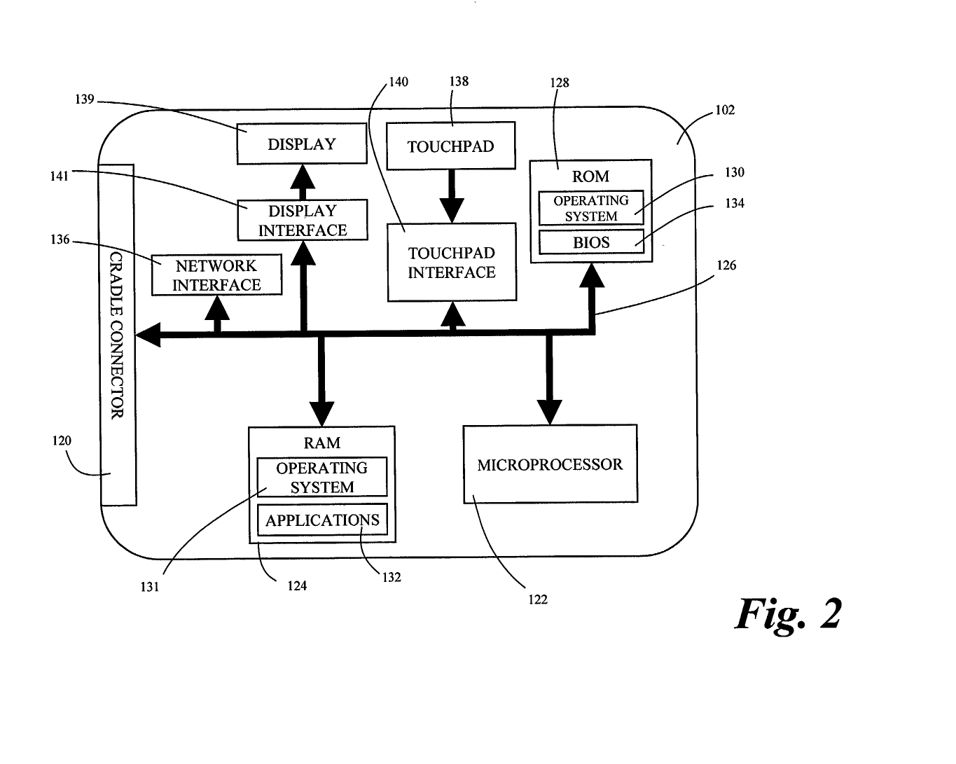

FIG. 2 is a block diagram depicting the primary components of an exemplary hand-held computer 102. Generally stated, the hand-held computer 102 is a general-purpose computing device implemented as a compact, hand-held user interface. The hand-held computer 102 includes a processing unit 122, a system memory 124, and a system bus 126 that connects various system components, including the system memory 124 to the processing unit 122. The hand-held computer may also include a read-only memory (ROM) 128 and a random access memory (RAM) 124. The ROM 128 may store an operating system 130 that can be transferred via the system bus 126 to the RAM 124. The RAM 124 may also be used to store applications 132 that can be executed by the processing unit 122. The ROM 128 may include a basic input/output system (BIOS) 134. The BIOS 134 can contain the basic computer instructions that enable the initial operation of the hand-held computer at startup. For example, the BIOS 134 may initiate the transfer of the operating system 130 from the ROM 128 to the RAM 124 at startup. Thereafter, the RAM version of the operation system 131 will control the basic operation of the handheld computer 102. Those skilled in the art will appreciate that the hand-held computer 102 could use any of various other memory devices not shown in FIG. 2, such as a hard disk drive, a removable disk drive, a cassette drive, a flash memory card reader, and the like.

The hand-held computer 102 can connect to the cradle (104, FIG. 1) via a cradle connector 120. The cradle connector 120 is connected to the microprocessor and all other system components via the system bus 126. Communications over the cradle connector 120 with the cradle and with any other network component connected to the communication network (110, FIG. 1) can be managed and controlled using a network interface 136. Those skilled in the art will appreciate that various well-known technologies could be implemented to provide the functionality of the network interface 136. In an alternative embodiment, the network interface can be implement as part of the cradle, rather than as part of the hand-held computer 102. This alternative implementation may be used to simplify the design of the handheld computer 102 or to reduce the weight of the handheld computer.

A user of the hand-held computer 102 may enter commands and data into the hand-held computer using an input device, such as a touchpad 138. The touchpad is a well-known input device that operates in conjunction with a display panel 139 over which the touchpad is accurately registered. For example, the display panel 139 can display data, graphics, and virtual buttons. The user can touch the touchpad directly over these virtual buttons to input data. The touchpad 138 can be connected to the system bus 126 via touchpad interface 140. The touchpad interface 140 can operate to receive user input from the touchpad 138 for subsequent processing by the processing unit 122 and/or storage in memory, such as RAM 124. The display interface 141 can also operate as a video rendering device receiving input from the processing unit 122 and causing the display panel 139 to render a graphic display. Because of the physical relationship of the touchpad 138 and the display panel, which are spatially co-extensive, the term “touchpad” is often used herein to means the combination of the touchpad and the display panel.

The applications 132 can be stored and executed from the ROM 128. Alternatively, the applications 132 can be stored and executed in the RAM 124. As described in connection with FIG. 1, the applications 132 may be transmitted to the hand-held terminal 102 from the data center (106, FIG. 1) or from the Distributor's DP System (101, FIG. 1). Upon receipt of an application 132, the hand-held computer 102 can recognize the application as such and store the application for subsequent execution. In a similar manner, data of various forms including inventory data, graphical data, program modules, operating system data, and the like can be transmitted to the hand-held computer 102. The operating system 130 and/or a specialized application 132 can be implemented to recognize and process the various forms of data that are received by the hand-held computer.

The hand-held computer 102 can be equipped with a battery pack that is not shown in FIG. 2. The battery pack can supply power for the operation of the components of the hand-held computer 102, when the hand-held is connected to the cradle. The battery pack can be recharged when the hand-held computer 102 is returned to the cradle. The hand-held computer 102 can be supplied with power directly through the cradle connector 120 while the hand-held computer is connected to the cradle. The cradle connector 120 can also be used to supply power for a recharging component (not shown) that can be built into the hand-held unit or the cradle to manage the recharging of the battery pack.

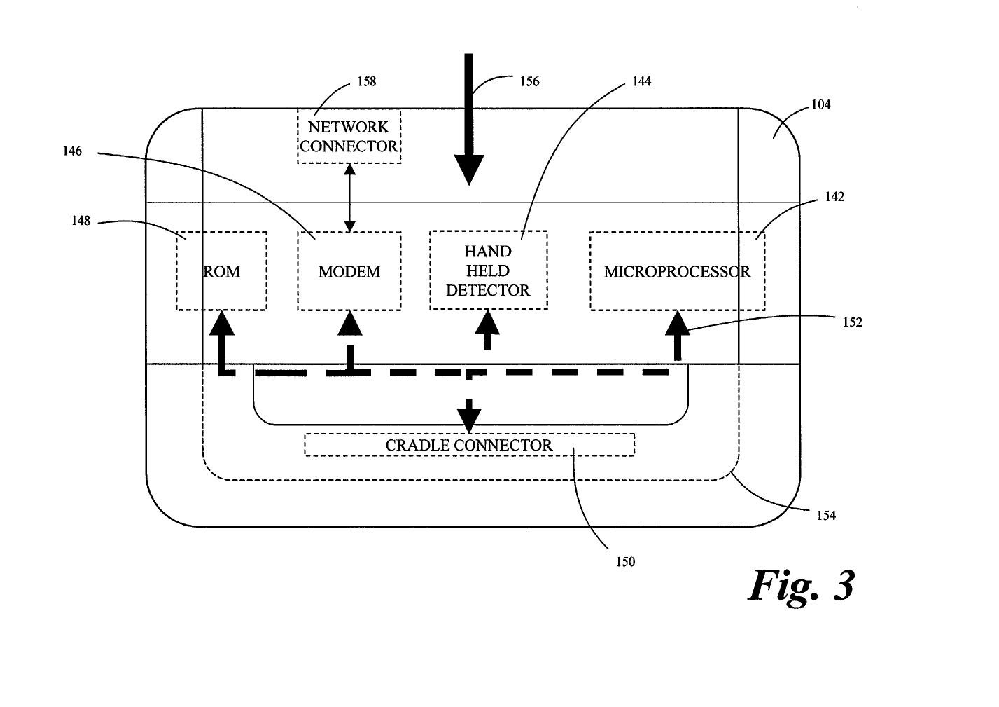

FIG. 3 is a block diagram depicting the primary components of a cradle 104 that is an exemplary embodiment of the present invention. The primary components of the cradle 104 are interconnected by a system bus 152. A processing unit 142 primarily controls the function of the other components and manages communications with the hand-held computer 102 (FIG. 2) via the cradle connector 150. The cradle connector 150 goes with the cradle connector 120 of the hand-held computer 102. When the cradle connectors are functionally coupled, the cradle 104 and the hand-held computer 102 can communicate. In addition, the cradle 104 can provide power to the hand-held computer 102 through the cradle connector 150. Those skilled in the art will appreciate that the cradle 104 can itself be connected to a power source, such as an AC power supply. It will also be appreciated that the cradle 104 may contain a power processing unit, such as a transformer to provide power to the cradle's components, as well as to the hand-held computer 102.

The hand-held computer 102 can be inserted into the cradle in the direction of arrow 156. The cradle 104 includes a device port 154 that has a shape that substantially conforms to a leading edge of the hand-held computer 102, such that the cradle connectors of the hand-held computer and of the cradle can be functionally coupled.

The cradle 104 also may include a hand-held detector 144 which detects the presence of the hand-held computer in the port 154. When the detector 144 detects the presence of the hand-held computer 102 in the port 154, communication between the hand-held terminal and the cradle can be commenced.

The cradle 104 also can include a read-only memory (ROM) 148. The ROM 148 can be used to store an operating system, a BIOS, application programs, and any other program module and/or data that is useful to the hand-held computer 102 and the cradle 104.

The cradle 104 can be connected to the network 110 via network connector 158. The network connector 158 can be implemented as any of a number of well-known connectors, such as the standard two wire telephone connector or a standard Ethernet connector. The cradle can also include a modem 146 for enabling communication between the cradle 104 and/or the hand-held computer 102 with the network 110 and other network elements (e.g., Distributor's DP System 101, data center 106). The processing unit 142 can route the data received over the network connector 158 to, for example, the ROM module 148 or the hand-held computer 102. In an alternative embodiment, the processing unit 122 of the hand-held computer 102 can perform this routing function.

Accordingly, the cradle 104 can function as the network intermediary between the hand-held computer 102 and the network 100. When the hand-held computer 102 is inserted into the port 154 of the cradle 104, the hand-held detector 144 can indicate to the processing unit 142 that the hand-held computer is present. The processing unit 142 can perform a hand-shaking process to ensure proper communication between the cradle 104 and the hand-held computer 102. Once proper communication has been established, the processing unit 142 may determine whether the hand-held unit 102 has a pending transmission (e.g., an order to be transmitted to the distribution system 101). If the processing unit 142 determines that the hand-held unit 102 has a pending transmission, the processing unit 142 will initiate a communication session with the appropriate network element, such as the data center 106.

This communication session can be established by use of the modem 146 in conjunction with the network connector 158. For example, with a telephonic connection, the processing unit 142 may cause the modem 146 to establish a telephonic connection with the data center 106. The processing unit 142 can perform a second hand-shaking process to ensure proper communication between the handheld computer 102 and the data center 106. Once the telephonic connection has been established, the processing unit 142 can instruct the hand-held computer 102 to begin to transmit its pending transmission. Those skilled in the art will appreciate that the processing unit 122 of the hand-held computer could perform all of the functionality ascribed to the processing unit 142 of the cradle 104.

If the hand-held computer 102 does not have a pending transmission, upon insertion into the cradle 104, the processing unit 142 of the cradle may enable the transmission of data to the hand-held computer. The automated order entry network 100 of an exemplary embodiment of the present invention contemplates two-way communication. For example, the distribution system 101 and/or the data center 106 may transmit data and/or program modules to the hand-held computer.

In an alternative embodiment, the cradle may be implemented as a pass-through device, providing only a functional connection to the network (e.g., telephone connector) and/or to the power supply. In this alternative embodiment, the cradle may have a telephone connector that can be virtually always connected to a functioning telephone line. The connectors of the hand-held computer and the cradle can provide the functional connection to connect the hand-held device with the telephone line. The connectors also could provide this sort of pass-through connection to a power supply connected to the cradle. In this alternative embodiment, the hand-held presence switch and the modem (and all other functional components) could be integrated in the hand-held device itself. Accordingly, all of the cradle functions described above would be performed by the hand-held device, rather than by the cradle.

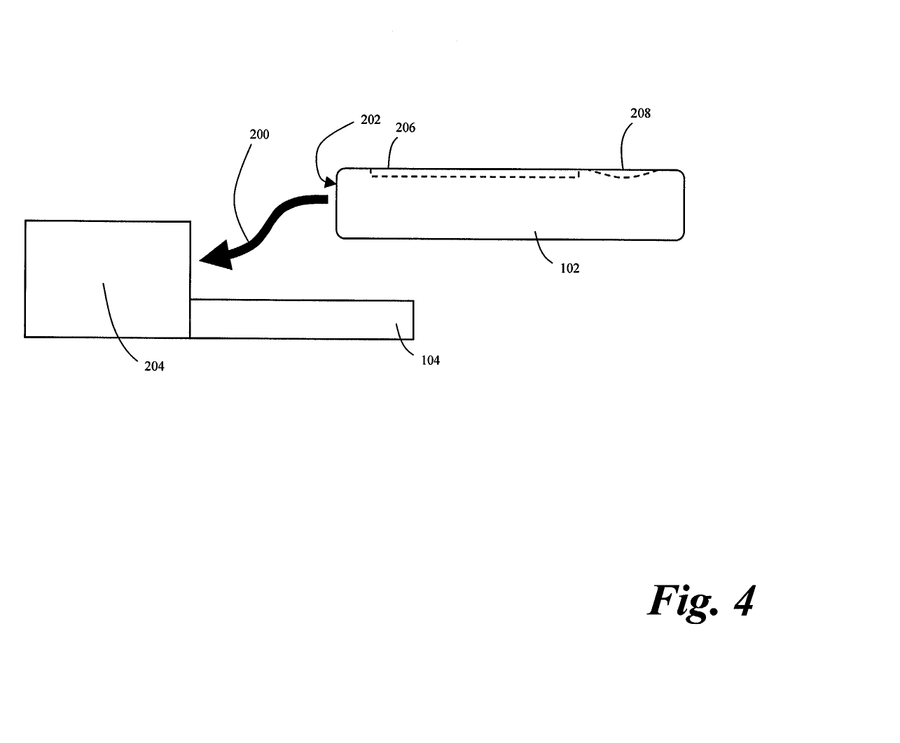

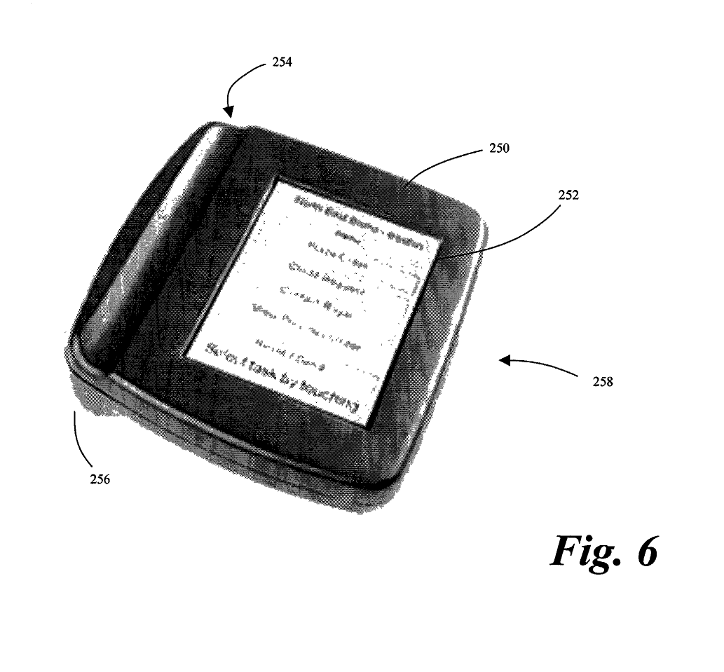

FIG. 4 is a simplified drawing depicting the physical relationship of a hand-held computer 102 that is disconnected from a cradle 104 of an exemplary embodiment of the present invention. The hand-held computer 102 can be inserted into the cradle 104 by moving the hand-held computer in the direction of arrow 200. The leading edge 202 of the hand-held computer 102 is inserted into the port 204 of the cradle 104. FIG. 4 is a side, elevation view of the hand-held computer 102 and the cradle 104. Dashed lines on the hand-held computer 102 depict the touchpad 206 and the grip 208. The touchpad 206 and the grip 208 are shown and described in more detail in connection with FIG. 6.

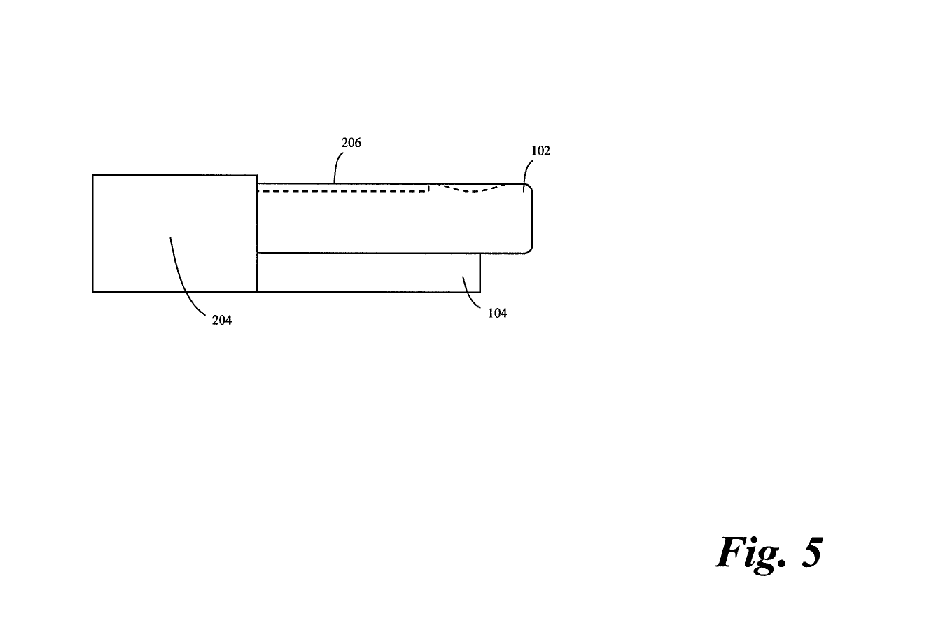

FIG. 5 is a simplified drawing depicting the physical relationship of the hand-held computer 102 inserted into a cradle 104 of an exemplary embodiment of the present invention. FIG. 5 depicts the hand-held computer 102 after it has been inserted into the port 204 of the cradle 104. As shown in FIG. 5, the leading edge of the hand-held computer 102 is no longer visible as it is located within the port 204. Although a portion of the touchpad 206 has also been inserted into the port 204, in one embodiment of the present invention, the cradle 104 can include a viewing window that enables the display panel to be seen, even when the hand-held computer 102 is inserted in the cradle 104.

FIG. 6 is a perspective view of a hand-held data entry computer 102 that is an exemplary embodiment of the present invention. The hand-held computer 250 includes a touchpad 252 that displays information and operates as an input device, enabling a user to touch portions of the touchpad to instruct the hand-held computer to perform various functions. The hand-held computer 250 is ergonomically designed to be held comfortably by data entry personnel. A grip channel 254 is designed to accommodate the thumb and the portion of a user's hand adjacent to the thumb. The grip channel can extend along substantially the entire edge of the hand-held computer 250. In an alternative embodiment, the grip channel 254 can have a longitudinal dimension less than the entire length of the hand-held computer 250. In any case, the grip channel 254 can be equipped with a texture to create a tackier surface, such as a knurled surface.

The hand-held computer also includes a grip handle 256. The grip handle can also extend along substantially the entire length of the hand-held computer 250. In an alternative embodiment, the grip handle 256 can extend along less than the entire length of the hand-held computer 250. The grip handle 256 is designed to accommodate the fingers of the user. Accordingly, the user can hold the hand-held computer 250 by placing its thumb in the grip channel 254 and wrapping its fingers around the grip handle 256. The grip can be used to extract the hand-held computer 250 from its cradle (not shown) and to stabilize the hand-held computer during order entry (i.e., while the user operates the touchpad 252). Advantageously, in an exemplary embodiment of the present invention, the hand-held computer 250 can be manufactured such that it is physically symmetric along an axis perpendicular to the grip channel 254. In this embodiment, the hand-held computer 250 is ambidextrous, in that the user can hold the hand-held computer with either a right hand or a left hand. The display of the hand-held computer 250 that is rendered in combination with the touchpad 252 can be inverted to accommodate this feature of the hand-held computer 250. In an alternative embodiment, the display can be rendered in any one of four orientations, such that the display can be view form any one side of the handheld computer.

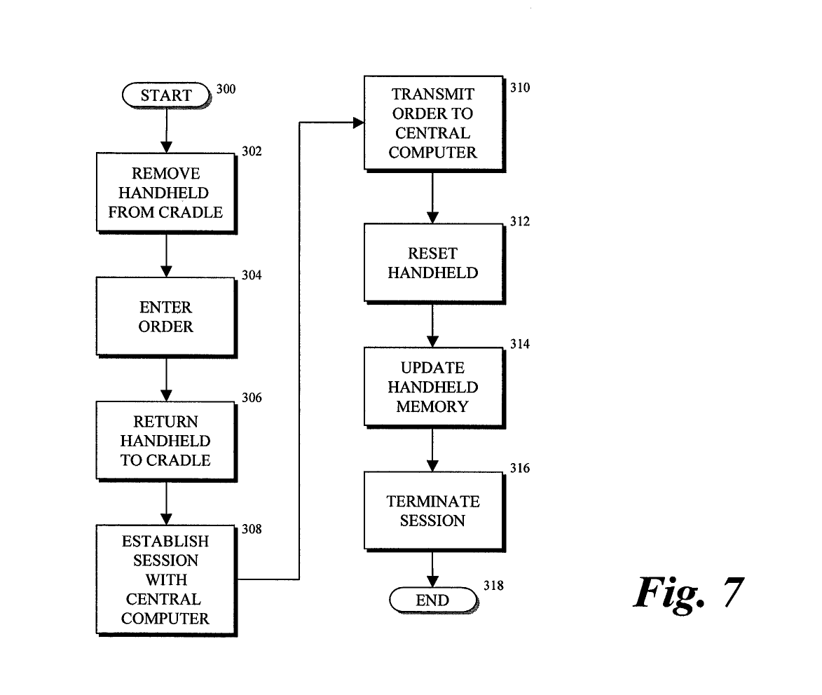

FIG. 7 is a flow chart depicting an exemplary method for data entry and transmission between a hand-held data entry computer and a central computer. The method of FIG. 7 begins at start block 300 and proceeds to step 302. At step 302, the hand-held computer is removed from the cradle. In the context of a restaurant, the restaurant personnel may move the hand-held from its cradle when an order needs to be sent to the inventory supply distributor. Typically, orders include regularly scheduled orders, such as a monthly or weekly orders or impromptu orders, such as when a particular inventory item has been unexpectedly exhausted.

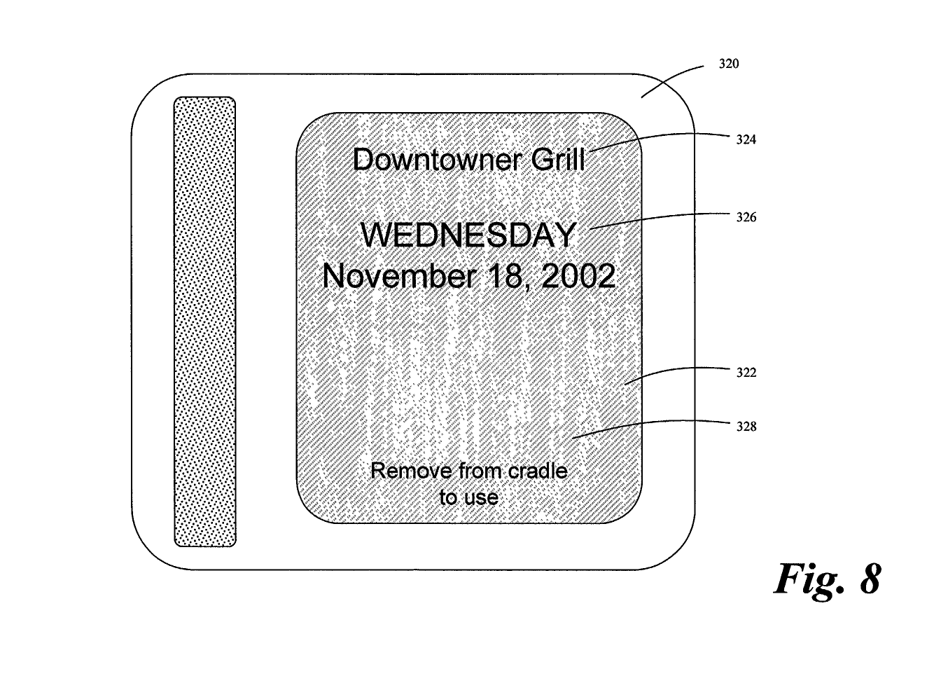

The method proceeds from step 302 to step 304. At step 304, an order is entered into the hand-held computer. An exemplary order entry method is described in more detail below in connection with FIGS. 8-16. The method proceeds from step 304 to step 306. At step 306, the hand-held computer is returned to the cradle. As described above in connection with FIGS. 1-3, the return of the hand-held computer to the cradle can trigger the initiation of a transmission between the hand-held computer and the central computer. For example, a hand-held detector may recognize a functional connection between the hand-held computer and the cradle. When this connection is recognized, a determination may be made as to whether the hand-held computer includes a pending order (i.e., a yet to be transmitted order) or other pending data. A separate determination may be made as to whether the central computer has indicated a need to transmit data to the hand-held computer. The central computer may indicate such a need by, for example, storing a transmission request in a memory location in the cradle. Alternatively, the hand-held computer may be configured to request any such transmissions from the central computer upon insertion into the cradle.

A method proceeds from step 306 to step 308. A step 308, a session is established between the central computer and the hand-held computer. As described above in connection with FIG. 3, an exemplary cradle may be a pass through connector between a modem in the hand-held computer and a network interface, or may include a modem and/or a network connector that can initiate a functional data communication link with the central computer. The modem may dial a predetermined telephone number to gain access to a modem pool associated with the data center.

In an alternative embodiment of the present invention, a session may be established with the data center by accessing an internet protocol (IP) address associated with the data center. For example, the combination of the hand-held computer and the cradle may be configured to access a predetermined website associated with the central computer and may transmit information between the hand-held computer and the central computer in, for example, HTML format, XML format, ASCII format, or Unicode format allowing the use of worldwide alphabets and languages on the display panel.

The method proceeds from step 308 to step 310. At step 310, the order is transmitted to the data center. The method proceeds to step 312, wherein the handheld computer is reset (e.g., the order is denoted as having been transmitted). The method proceeds from step 312 to step 314. At step 314, the memory of the handheld computer is updated. The memory update may include resetting the order entry forms and moving a transmitted order from a pending order location to a transmitted order memory location. The memory update may include the transmission of new or replacement applications from the central computer to the hand-held computer's memory. The memory update may also include the removal of old order entry records and the replacement of operating system modules and/or any other program modules stored in the hand-held computer's memory. In an alternative embodiment of the present invention, step 314 may also include the updating of memory in the cradle.

The method proceeds from step 314 to step 316. At step 316, the communication session with the data center is terminated. In this step, the hand-held computer may return to a stand-by mode and await either the removal from the cradle, a communication session initiated by the central computer, or an entry session initiated by a user's touching the touchpad. The method proceeds from step 316 to end block 318 and terminates.

FIG. 8 is a simplified drawing depicting the top surface of an exemplary hand-held computer 320. The touchpad 322 of the hand-held computer 320 is displaying a default screen that can be displayed when the hand-held computer is in a stand-by mode. As described above in connection with FIG. 7, the hand-held computer may maintain a stand-by mode when it is inserted in the cradle. In this mode, hand-held computer's touchpad may display the name of the organization to which it is associated 324 (e.g., “Downtowner Grill”). The touchpad may also display the date and time 326. The default display of the touchpad may also include the instruction to remove the hand-held computer from the cradle for use. In an alternative embodiment, the hand-held computer may be equipped to operate while connected to the cradle. In such an alternative embodiment, the removal instruction 328 may be eliminated from the stand-by mode display (i.e., the default display).

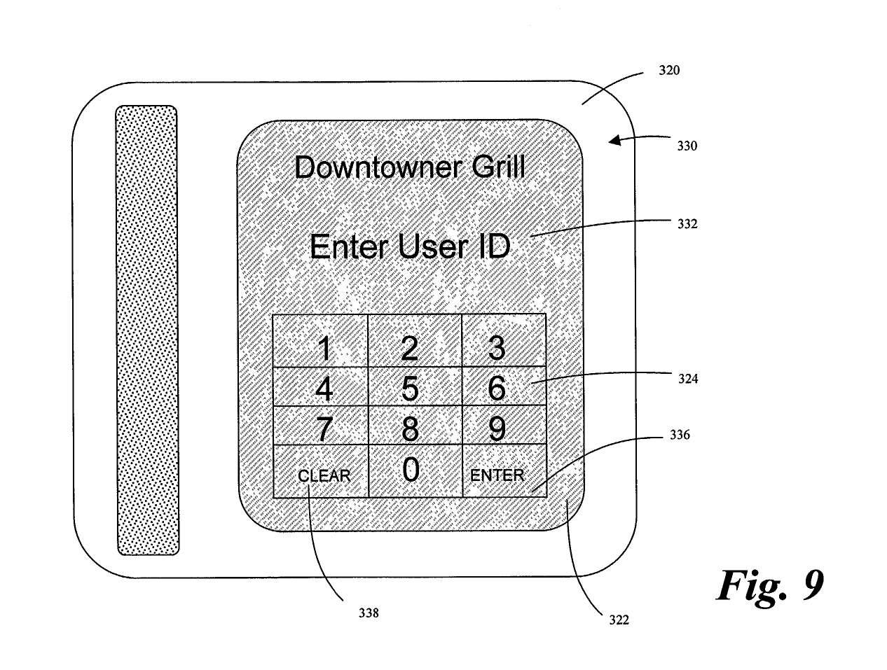

FIG. 9 depicts an access display 330 that may be used to restrict access to the operation of a hand-held data entry computer 320 of an exemplary embodiment of the present invention. In this exemplary access display 330, and instruction message 332 instructs the user to enter an access code or a user ID. The input/output area 322 can display a virtual keypad 324, which can be used by the user to enter a sequence of numbers corresponding to the user's access code. Following entry of the access code, the user can press a virtual “enter” button 336 to submit the access code to the hand-held computer. The user may cancel an erroneous access code entry by pressing the virtual “clear” button 338. Once a correct access code or user ID has been entered into the hand-held computer 320, access to the other functionality of the hand-held can be granted to the user.

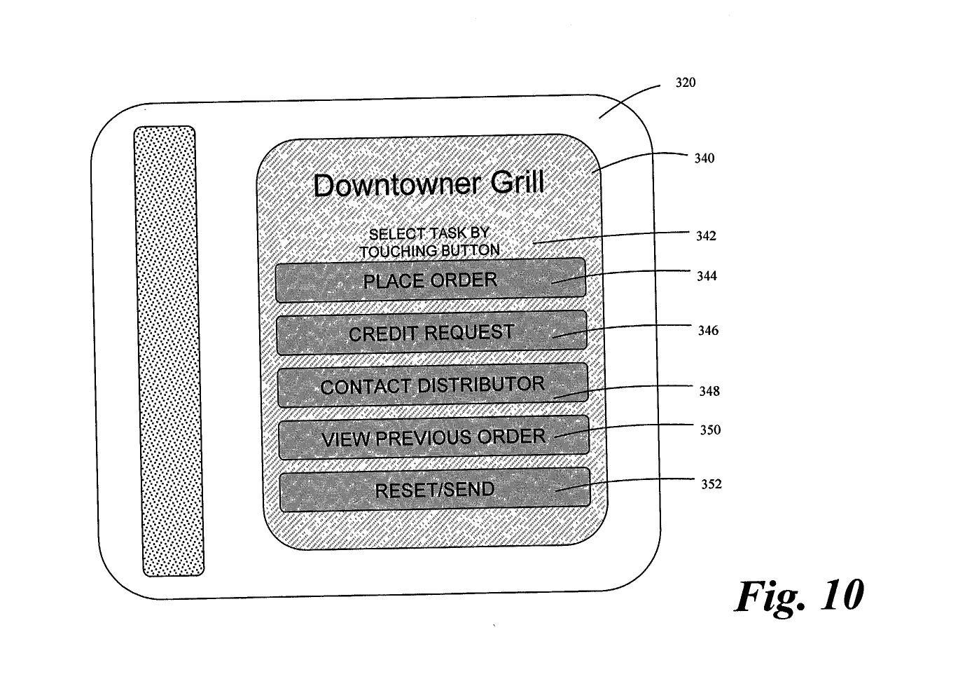

FIG. 10 depicts a hand-held computer 320 with a display that is displaying a top-level order-entry menu computer screen 340. The menu screen 340 includes an on-screen instruction 342, instructing the user to select a task by pressing a virtual button displayed in the menu screen 340. In the order entry context, the buttons may include a “place order” button 344, a “credit request” button 346, a “contact distributor” button 348, a “review previous order” button 350, and a “reset/send” button 352. Those skilled in the art will appreciate that the virtual buttons depicted in FIG. 10 pertain to the use of an exemplary hand-held computer 320 in the order-entry context. It will be further appreciated that the various other virtual buttons may be appropriate to the use of the exemplary hand-held computer 320 in other data entry context. Although the use of the automated data entry system is described in the general context of order entry and in the specific context of a restaurant distribution system, it will be appreciated that the automated data entry system could be used in a variety of data entry context.

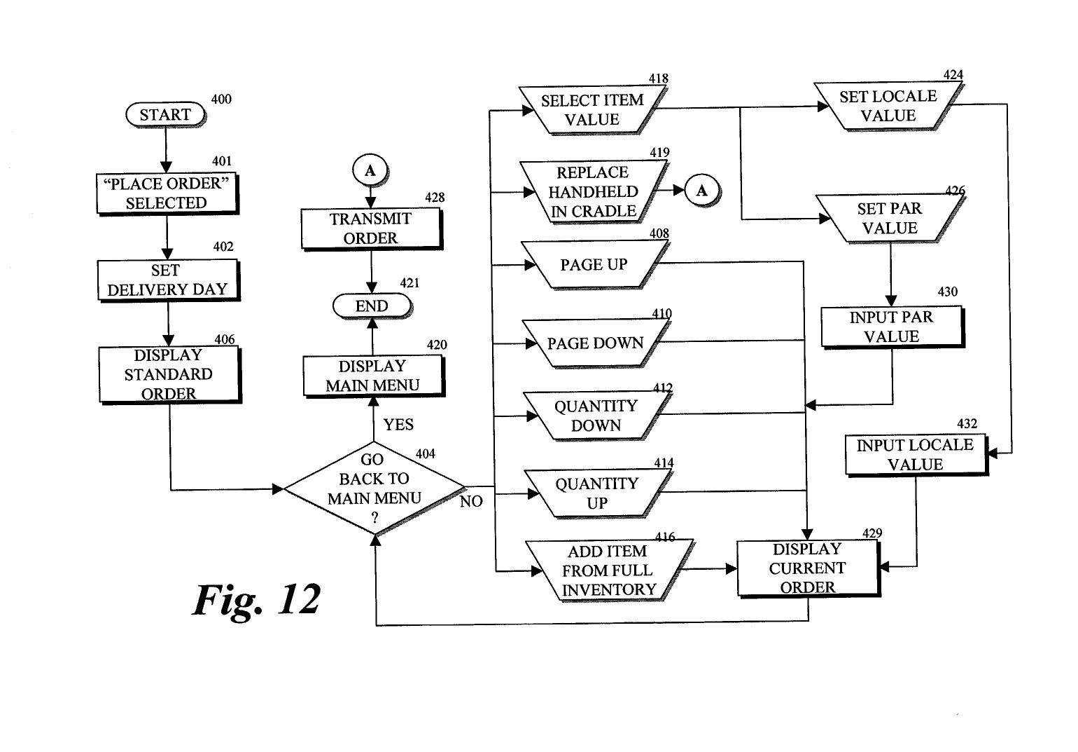

The “place order” virtual button 344 can be used to initiate the order entry functionality of the hand-held computer 320. The “credit request” virtual button 346 may be used to transmit a credit request form to a central computer for subsequent processing. The “contact distributor” virtual button 348 may be used to transmit a request for a subsequent communication with the personnel of the distributor. The “view previous order” virtual button 350 may be used to display a history of previously transmitted orders. Finally the “reset/send” virtual button 352 may be used to cancel a pending order (i.e., and entered but not transmitted order) or to transmit a pending order. The operation of the hand-held computer 320 following the election of one of the virtual buttons 344-352 will be described in more detail in connection with FIGS. 12 through 16.

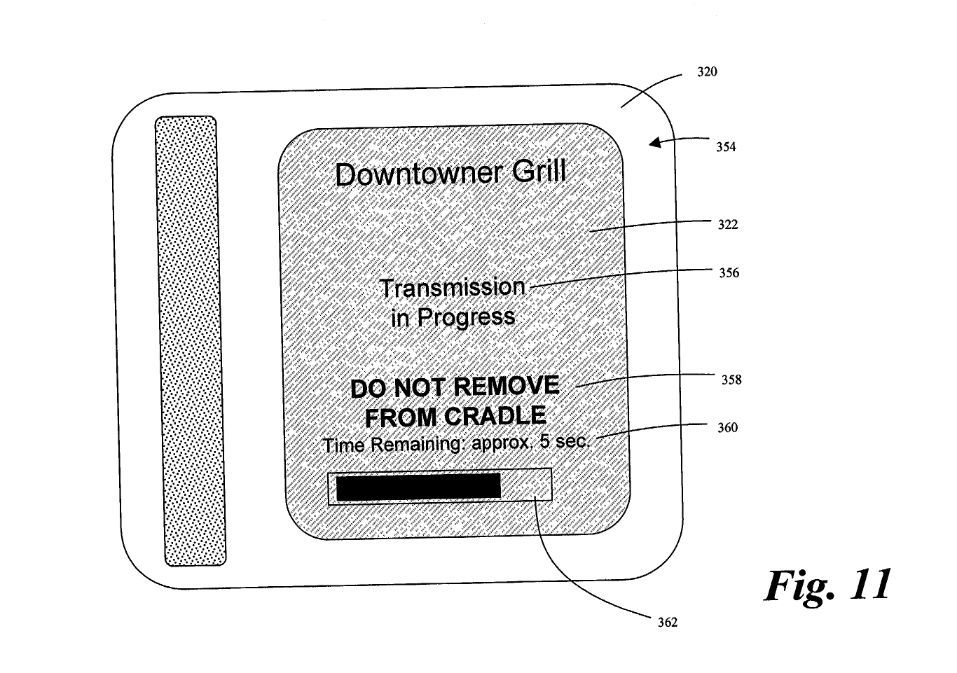

FIG. 11 depicts an exemplary transmission display that may be rendered on the input/output area 322 of a hand-held data entry computer 320 of an exemplary embodiment of the present invention. The transmission display 354 can include a warning 356 notifying the user that the transmission operation is in progress. The transmission operation can be performed when the hand-held computer 320 has been returned to its cradle or when a transmission has been initiated by the central computer. Typically, the removal of the hand-held computer 320 from the cradle during transmission will prohibit a complete transmission. Accordingly, a nonremoval instruction 358 can be displayed to warn the user to avoid removal from the cradle. Finally, the transmission display 354 can display progress information, such as time remaining data 360 or a progress bar 362.

FIG. 12 is a flowchart depicting an exemplary method for managing and order entry transaction. The method begins at start block 400 and proceeds to step 401. At step 401, the “place order” selection is made. Typically, this selection will be made by a user pressing the “place order” virtual button on the touchpad of the hand-held device. The method proceeds from step 401 to step 402. At step 402, the user is prompted to enter a delivery day and the delivery day is set. The user may be asked to enter a delivery day or a default delivery day may be provided that can be verified or modified.

The method of FIG. 12 proceeds from step 402 to step 406. At step 406, the standard order is displayed. Typically, there will be a standard order associated with either the user or the hand-held device. This standard order can be displayed to facilitate the order entry process. In an alternative embodiment, the user may be provided with a completely blank order entry form that does not include any standard order information. The method proceeds from step 406 to decision block 404, wherein a determination is made as to whether the user desires to return to the main menu. The user may at any time select to return to the main menu, thereby terminating the order entry process. If a determination is made that the user desires to return to the main menu without completing the order entry process, the method may branch from decision block 404 to step 420. At step 420, the main menu is displayed. The method proceeds from step 420 to end block 421 and terminates. In an alternative embodiment, the order entry procedure can be placed on “hold,” when the user returns to the main menu, such that any entered order information can be retained and the order entry process can be resumed.

Returning to decision block 404, if a determination is made that the user has selected to return to the main menu, the method proceeds from decision block 404 to manual actions 408-419. These actions can be performed by the user at the same point in the method of FIG. 12. The user may perform any of the actions 408-419 at this point in the exemplary method. While the standard order is still displayed, as performed in step 406, the user may selected a “page up” option 408 or a “page down” option 410. These options enable the user to navigate through the pages of a displayed standard order or any other order that is displayed. The user may control the quantity of an order item by selecting a “quantity down” option 412 or a “quantity up” option 414. For example, if an item on the standard order is associated with a standard quantity (i.e., a par value) that is too high or too low for the user's immediate needs, the quantity options 412, 414 may be used to modify the quantity. User may also select an option to add an item from the full inventory 416. This option is used to modify the standard order or to modify any order that is being edited by adding an item from a full inventory list. The full inventory list may be transmitted from the data center to the hand-held computer and stored in memory. Alternatively, the full inventory list may be maintained on the data center and accessed in real time by the hand-held computer on a page-by-page basis. In any event, once the item has been added to a particular order, the quantity of that item can be adjusted as described above.

The user may also be provided with a “select item value” option 418. If the user selects the “select item value” option 418, the user may be provided with two other sub-options, the “set locale value” option 424 and the “set par value” option 426. If the user selects the “set locale value” option 424, the method proceeds to step 432 and a number representing the location in the standard order for a particular item may be entered. This locale value is useful for organizing a standard order, such that associated items can be sequenced together. For example, all frozen items may be grouped together within the standard order by assigning similar and/or consecutive local values to those items.

This sequencing can exploit the off-line order entry capabilities of the hand-held computer. One of the benefits for having the off-line order entry capabilities of the exemplary hand-held computer is to enable the entry of an order “or other data” in a manner that allows the order entry personnel full freedom of motion. The locale value method of order entry further expedites the order entry process by enabling the creation of a sequence standard order. Accordingly, in the context of an exemplary restaurant order entry process, the order entry personnel may follow an established path through a stockroom, a refrigerator, a freezer, and the like. Of course, this is true for any data entry user of the hand-held computer. For example, if the hand-held computer is used for data entry and any context that utilizes a predetermined sequence, the locale value standard order structure can be beneficial.

Returning to FIG. 12, another item value that can be set is the par value. The user selects the “set par value” option 426, the method will proceed to step 430 and a default par value associated with an item in the standard order may be modified.

Selection of any of the menu options 408-416, 424, 426 can result in the display of the updated current order at step 429. Thus, at step 429, the new order or a revised currently edited order will be displayed. The method proceeds from step 429 to decision block 404. At decision block 404, a determination is made as to whether the user desires to return to the main menu and proceeds as described as above. At any point in the process, the user may perform the manual operation of replacing the hand-held in the cradle 419. If the user places the hand-held in the cradle, the method will proceed from manual operation 419 to step 428. At step 428, any pending order and/or other information will be transmitted to the data center. The method proceeds from step 428 to end block 421 and terminates. Once the order has been transmitted, the hand-held will return to a standby mode as described above.

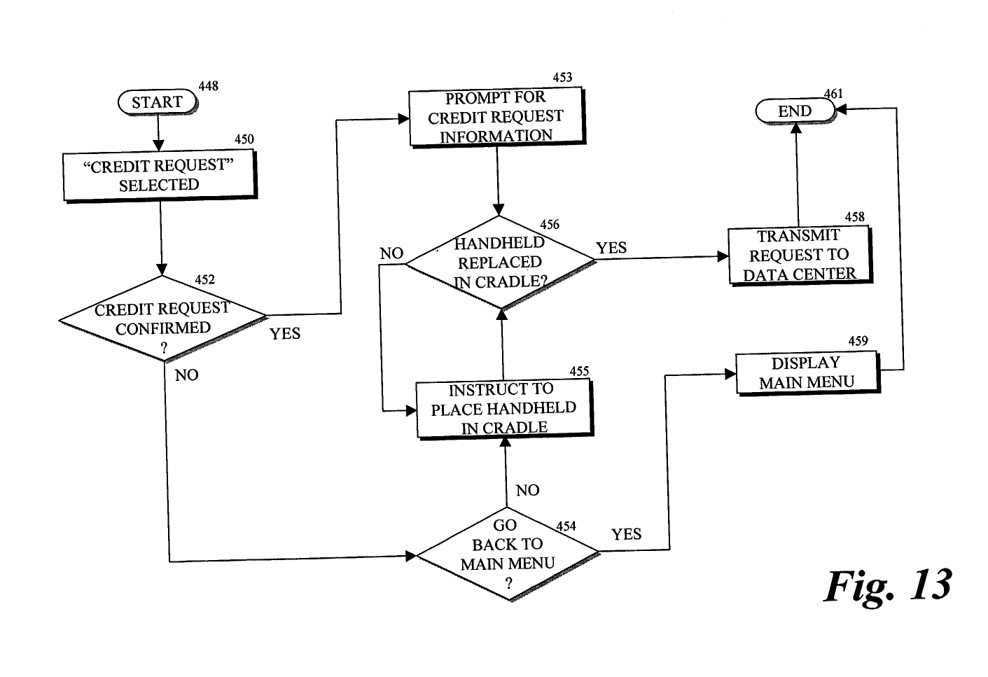

FIG. 13 is a flowchart depicting an exemplary method for receiving and transmitting a credit request. Method of FIG. 13 begins at start block 448 and proceeds to 450. At step 450, a “credit request” option is selected. The method proceeds from step 450 to decision block 452, wherein a determination is made as to whether the credit request is confirmed. Typically, the operation of decision block 452 is performed by the hand-held computer prompting the user to confirm the user's request to notify a distributor of the credit request. If a determination is made that the user has not confirmed the credit request, then it will branch to decision block 454. At decision block 454, a determination is made as to whether the user has selected to return to the main menu. If such a selection has been made, the method proceeds to step 459 and the main menu is displayed. The method proceeds from step 459 to end block 461 and terminates.

Returning now to decision block 454, if a determination is made that the user has not selected to return to the main menu, the method branches from decision block 454 to step 455. At step 455, the user is instructed to place the handheld in the cradle. The method proceeds from step 455, to decision block 456, wherein a determination is made as to whether the hand-held has been replaced in the cradle. If the hand-held has not been replaced it the cradle, the method branches from decision block 456 to step 455, and the user is prompted to return the hand-held to the cradle until the user does so. If a determination is made at decision block 456 that the hand-held has been replaced in the cradle, the method proceeds from decision block 456 to step 458. At step 458, the credit request is transmitted to the data center. The method proceeds from step 458 to end block 461 and terminates.

Returning now to decision block 452, if a determination is made that the credit request is confirmed, the method branches from decision block 452 to step 453. At step 453, the user is prompted for any needed credit request information. The method proceeds from step 453 to decision block 456 and proceeds as described above.

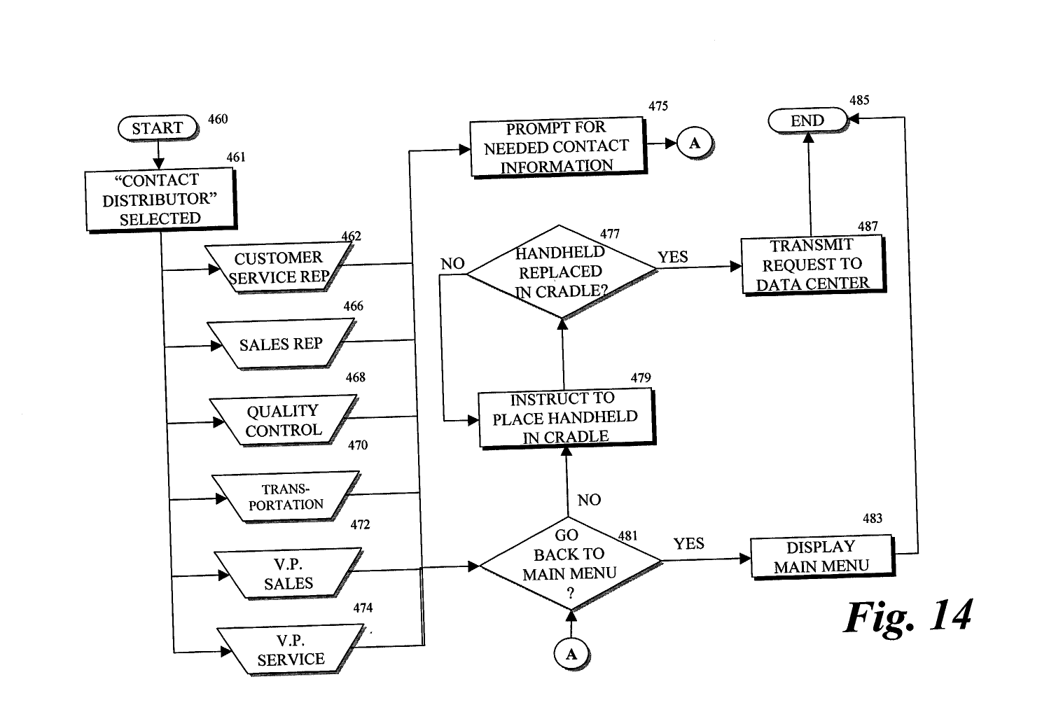

FIG. 14 is a flowchart depicting an exemplary method for receiving and transmitting a request for distributor contact. The method begins at start block 460 and proceeds to step 461. At step 461, the user selects the “contact distributor” option. When the user selects the “contact distributor” option, the user will be provided with a sub-menu of options represented by annual operations 462-474. The available options 462-474 are generally means for routing a contact request to a particular department associated with the distributor. Accordingly, the options may include a “customer service representative” option 462, a “sales representative” option 466, a “quality control representative” option 468, a “transportation department” option 470, a “vice-president of sales” option 472, and a “vice-president of service” option 474. Those skilled in the art will appreciate that these option titles are arbitrary in any routing destination identifier could be used to distinguish one option from the others. The method proceeds from manual operations 462-474 to step 475. At 475, the user is prompted to supply any needed contact information. The method proceeds from step 475 to decision block 481.

At decision block 481, a determination is made as to whether the user has selected to return to the main menu. If such a selection has been made, the method proceeds to step 483 and the main menu is displayed. The method proceeds from step 483 to end block 485 and terminates.

Returning now to decision block 481, if a determination is made that the user has not selected to return to the main menu, the method branches from decision block 481 to step 479. At step 479, the user is instructed to place the handheld in the cradle. The method proceeds from step 479, to decision block 477, wherein a determination is made as to whether the hand-held has been replaced in the cradle. If the hand-held has not been replaced it the cradle, the method branches from decision block 477 to step 479, and the user is prompted to return the hand-held to the cradle until the user does so. If a determination is made at decision block 477 that the hand-held has been replaced in the cradle, the method proceeds from decision block 477 to step 487. At step 487, the contact request is transmitted to the data center. The method proceeds from step 487 to end block 485 and terminates.

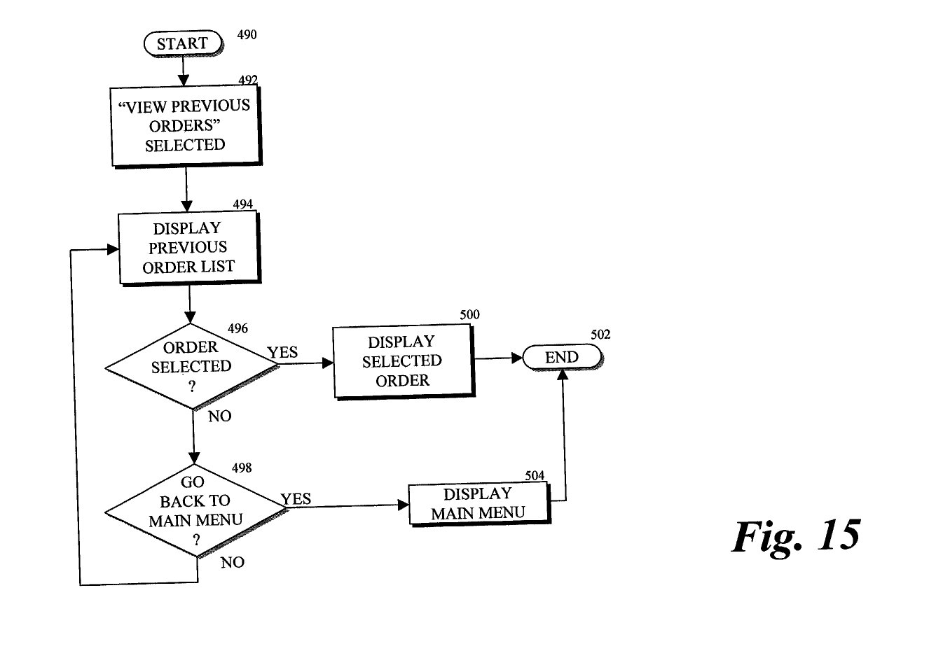

FIG. 15 is a flowchart depicting an exemplary method for displaying previous orders. The method of FIG. 15 begins at start block 490 and proceeds to step 492. At step 492, the “view previous orders” option is selected. Typically, the user will select the “view previous orders” option to review orders that have been entered in the hand-held computer and stored in memory. The method proceeds from step 492 to step 494 and a previous order list is displayed. The previous order list can include orders that were recently transmitted to the data center. A policy may be established as to the number of list items maintained in the hand-held computer's memory. For example, the hand-held computer could be configured to delete orders that are more than thirty days old or to delete orders causing the previous order list to exceed a predefined number of orders. The method proceeds from step 494 to decision block 496. At decision block 496, a determination is made as to whether the user has selected a particular order. If the user has selected a particular order, the method branches to step 500. At step 500, the selected order is displayed. When the user is finished viewing the displayed selected order, the method proceeds from step 500 to end block 502 and terminates.

Returning now to decision block 496, if a determination is made that an order is not selected, the method branches from decision block 496 to step 498. At step 498, a determination is made as to whether the user has selected to return to the main menu. If the user has selected to return to the main menu, the method branches to step 504, wherein the main menu is displayed. The method proceeds from step 504 to end block 502 and terminates. If at decision block 498, a determination is made that the user has not chosen to return to the main menu (and has not selected an order for display), the method branches to step 494 and the previous order lists remain displayed until either an order is selected or the user selects to return to the main menu.

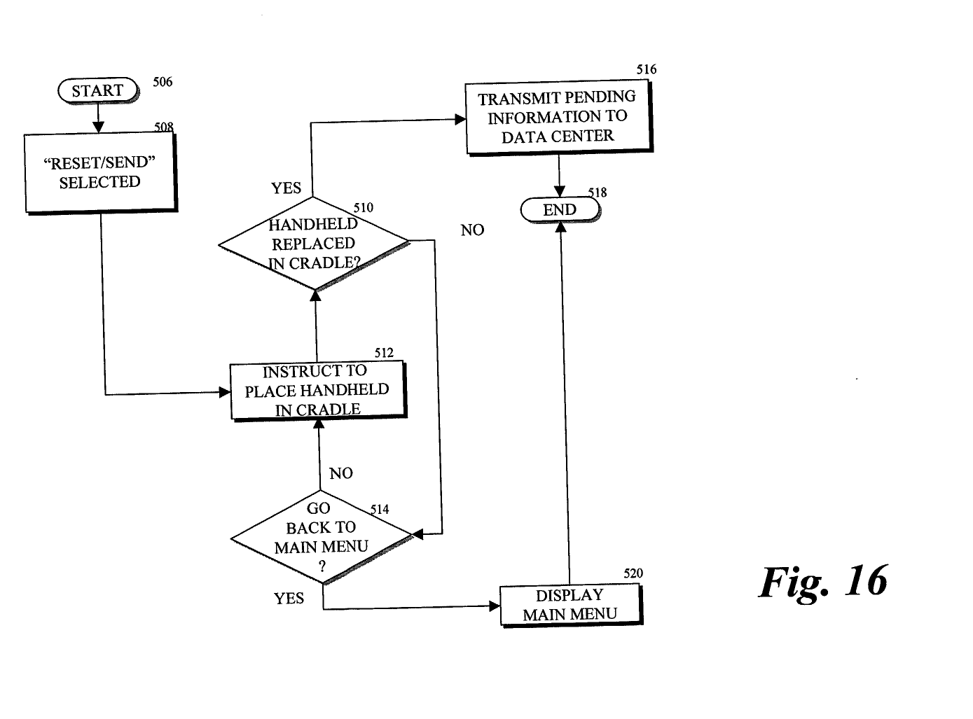

FIG. 16 is a flowchart depicting an exemplary method for transmitting information to a data center. The method of FIG. 16 begins at start block 506 and proceeds to step 508. As step 508, the “reset/sent” option is selected. The method proceeds form step 508 to step 512, wherein the user is instructed to replace the hand-held computer in the cradle. The method proceeds from step 512 to decision block 510, wherein a determination is made as to whether the user has replaced the hand-held in the cradle. If a determination is made at decision block 510 that the user has not placed the hand-held in the cradle, the method branches to step 514 and a determination is made as to whether user has selected to return to the main menu. If the user has not selected to return to the main menu, the method branches to step 512 and the user is continually instructed to replace the hand-held in the cradle until the user does so or selects to return to the main menu. If, on the other hand, a determination is made at decision block 514 that the user has selected to return to the main menu, the method branches to step 520 and the main menu is displayed. The method proceeds from step 520 to end block 518 and terminates.

Returning now to decision block 510, if a determination is made that the hand-held has been replaced in the cradle, it branches to step 516. At step 516, any pending information in the hand-held computer will be transmitted to the data center as described above. The method proceeds from step 516 to end block 518 and terminates.

Although the present invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A method for collecting data from a hand held computer and transmitting the data to a data center, the method comprising the steps of:
receiving a first data set, while the independent hand held computer is operating in an off-line mode;
storing the first data set, in response to a determination that the receipt of the first data set is complete;
establishing a communication link with data center, in response to a determination that the independent handheld computer has been functionally connected to the data center, thereby placing the independent hand held computer in an on-line mode;
transmitting the first data set to the data center, while the independent handheld computer is operating in an on-line mode.

2. The method of claim 1, further comprising the step of transmitting a second data set from the data center to the independent hand held computer, while the independent computer is operating in an on-line mode.

3. The method of claim 2, wherein the second data set is a standard order.

4. The method of claim 2, wherein the second data set is a program module.

5. The method of claim 2, wherein the data center receives the second data set from a remote data processing system.

6. The method of claim 5, wherein the data center is further operative to transmit the first data set to a remote data processing system.

7. The method of claim 1, wherein the functional connection between the hand held computer and the data center is a telephone connection.

8. The method of claim 1, wherein the functional connection between the hand held computer and the data center is an internet connection.

9. The method of claim 6, wherein the data center is functionally connected to the remote data processing center over a telephone connection.

10. The method of claim 6, wherein the data center is functionally connected to the remote data processing center over an internet connection.

11. A method for automatically establishing a connection between a hand-held computer and a remote computer, the method comprising the steps of:
making a determination that the hand-held computer has been functionally connected to a cradle;
establishing a telephonic connection between the remote computer and the hand held computer, in response to the determination that the hand-held computer has been functionally connected to a cradle; and
enabling the transmission of data between the hand-held computer and the remote computer, in response to a determination that the telephonic connection has been established.

12. The method of claim 11, wherein the determination that the hand-held computer has been functionally connected to the cradle comprises monitoring a hand-held presence detector.

13. The method of claim 11, wherein the cradle has a modem that is operative to perform the step of establishing the telephonic connection with the remote computer.

14. The method of claim 11, wherein the remote computer is a data center.

15. The method of claim 14, further comprising the step of transmitting the data set from the remote computer to an automated distribution system.

16. The method of claim 15, wherein the automated distribution system is operative to convert the data set into an order and to schedule the delivery of at least one item to a location associated with the hand-held computer.

17. The method of claim 11, wherein the remote computer is a remote data processing system.

18. A method for collecting data representing an order, comprising:
storing a standard order, the standard order comprising a plurality of item identifiers and corresponding quantities;
presenting each item identifier in association with the corresponding quantity for order confirmation; and
placing an order for a first item identifier and a first corresponding quantity, in response to a determination that the first item identifier and a first corresponding quantity have been confirmed;
wherein each of the plurality of item identifiers also has a corresponding locale value and wherein the first item identifier and the first corresponding quantity are presented for order confirmation in a sequence in relation to a second item identifier and a second corresponding quantity, based on the relative values of a first locale value and a second locale value.

19. A data collection system for collecting, storing, and transmitting a data set, comprising:
an independent hand-held computer operative to receive the data set;
a cradle operative to transmit the data set to a data center, when functionally connected to the independent hand-held computer; and
the data center operative to receive the data transmission from the independent hand-held computer and to store the data set;
wherein the independent hand-held computer receives the data set while operating in an off-line mode and transmits the data set to the data center while operating in an on-line mode.

20. The data collection system of claim 19, wherein the hand held computer operates in an on-line mode in response to a determination that a telephone connection has been established
